(19) United States
(12) Patent Application Publication
(10) Pub. No.: US 2014/0372838 A1
(43) Pub. Date: Dec. 18, 2014

(54) Bad disk block self-detection method and apparatus, and computer storage medium

(71) Applicant: TENCENT TECHNOLOGY (SHENZHEN) COMPANY LIMITED, Shenzhen, Guangdong (CN)

(72) Inventors: Jibing Lou, Shenzhen (CN); Jie Chen, Shenzhen (CN); Chujia Huang, Shenzhen (CN)

(21) Appl. No.: 14/368,453

(22) PCT Filed: Apr. 25, 2013
(86) PCT No.: PCT/CN2013/074748

§ 371 Date: Jun. 24, 2014

(30) Foreign Application Priority Data
May 9, 2012 (CN) 201210142205.4

(51) Int. Cl. G06F 11/10; G06F 3/06

(52) U.S. Cl. CPC G06F 11/1076; G06F 3/0619; G06F 3/0647; G06F 3/0689
USPC 714/801

(57) ABSTRACT

It is described a bad disk block self-detection method, including: each mounted chunk is partitioned into n sub-chunks, all sub-chunks having a same size, where n is an integer not less than 2; checking information is set at a fixed location of each sub-chunk, data is stored onto locations of each sub-chunk other than the fixed location, where the checking information is parity checking information for the data; and when the data is read or written, data verification is performed based on the checking information set at the fixed location of the read sub-chunk. It is also described a bad disk block self-detection apparatus and a computer storage medium. With the described above, the bad block on the disk can be detected rapidly, and it is able to instruct data migration and disk replacement.

The present application claims the priority of CN application No. 201210142205.4, entitled “a bad disk block self-detection method and apparatus,” filed on May 9, 2012 by Shenzhen Tencent Computer Systems Co., LTD, the disclosure of which is hereby incorporated by reference herein in its entirety.

### TECHNICAL FIELD

The present disclosure relates to data storage technology, and in particular to a bad disk block self-detection method and apparatus, and a computer storage medium.

### BACKGROUND

It is known that a magnetic medium of a hard disk is used to store data in logic unit of blocks. The situation where it is unable to read or write a sector or a bit error occurs in the data stored on a block may result in a bad block, which makes the data unavailable. In order to ensure the data available, a storage system needs to be able to detect any bad block on the disk, so as to avoid a read-write operation of the bad block, and to migrate significant data. Generally, redundant information is stored based on the data, and it is determined whether there is a bad block based on the redundant information in the next read-write operation. Typical methods for data redundancy are such as Error-Checking and Correcting (ECC) and Redundant Array of Independent Disk 5/6 (RAID 5/6).

The ECC, which is a Forward Error Correction (FEC) method, is originally applied in error check and correction of a communication system to enhance the reliability of communication system. Due to its reliability, the ECC is also applied in disk data storage, and is generally built in a disk system.

The ECC is implemented through coding a chunk (data block). Generally, it is calculated parity check information based on rows and columns of the chunk, and the parity check information is stored onto the disk as the redundant information. A schematic diagram for the ECC check of a 255-byte-chunk is shown in Table 1.

In Table 1, CPᵢ (i=0, 1, 2, 4) is a redundancy obtained through performing the parity check on the column data of the chunk.

RPᵢ (i=0, 1, 2 . . . 15) is a redundancy obtained through performing the parity check on the row data of the chunk.

When the chunk is read, column check and row check are performed on the chunk based on the column redundancy and row redundancy. As be seen from Table 1, when 1 bit error occurs in the data, it will lead to a series of errors in the parity check. The specific column on which an error is located may be determined through the column-parity check of the redundancy, and the specific row on which an error is located may be determined through the row-parity check of the redundancy. The bit error may be corrected based on a row numbering and a column numbering.

TABLE 1

| | | | | | | | | | | | | |
|---|---|---|---|---|---|---|---|---|---|---|---|---|
| Byte 0 | Bit 7 | Bit 6 | Bit 5 | Bit 4 | Bit 3 | Bit 2 | Bit 1 | Bit 0 | RP0 | RP2 | . . . | RP14 |
| Byte 1 | Bit 7 | Bit 6 | Bit 5 | Bit 4 | Bit 3 | Bit 2 | Bit 1 | Bit 0 | RP1 | | | |
| Byte 2 | Bit 7 | Bit 6 | Bit 5 | Bit 4 | Bit 3 | Bit 2 | Bit 1 | Bit 0 | RP0 | RP3 | | |
| Byte 3 | Bit 7 | Bit 6 | Bit 5 | Bit 4 | Bit 3 | Bit 2 | Bit 1 | Bit 0 | RP1 | | | |
| . . . | . . . | . . . | | | | | | | | | | |
| Byte 253 | Bit 7 | Bit 6 | Bit 5 | Bit 4 | Bit 3 | Bit 2 | Bit 1 | Bit 0 | RP1 | RP2 | | RP15 |
| Byte 254 | Bit 7 | Bit 6 | Bit 5 | Bit 4 | Bit 3 | Bit 2 | Bit 1 | Bit 0 | RP0 | RP3 | | |
| Byte 255 | Bit 7 | Bit 6 | Bit 5 | Bit 4 | Bit 3 | Bit 2 | Bit 1 | Bit 0 | RP1 | | | |
| | CP 1 | CP 0 | CP 1 | CP 0 | CP 1 | CP 0 | CP 1 | CP 0 | | | | |

| | | | |
|---|---|---|---|
| CP 3 | CP2 | CP 3 | CP2 |

| | |
|---|---|
| CP5 | CP4 |

Under the circumstance that there is a single-bit burst error in the chunk, the ECC can correct the single-bit burst error. However, when a multi-bit error occurs, the ECC can only check the error, but is unable to recover the data. The ECC is not applicable to the occasion with higher requirement for data security, therefore a backup of a file is required.

In addition, only when the in-out (IO) read-write operation of the chunk is performed can the ECC detect the error. Moreover, with the increase of the chunk size, the possibility that the multi-bit error occurs in the chunk increases as well, as a result the ECC has been unable to cope with such a situation. In addition, the ECC is generally implemented by hardware, and does not have abilities in function extension and customization.

With regard to space efficiency, as shown in Table 1, if the chunk is of n bytes, then the number of the additional ECC bit is log 2n+5. For example, for a 255-byte chunk, a redundancy of log 2*255+6=22 bit is required, and an effective utilization rate of the space is 22/(255*8)=98.9%.

The RAID 5/6 is referred to as a disk array of distributed parity check. Check information is not stored onto one disk, but is distributed to respective disks in the form of chunk crossover as shown in FIG. 1 and FIG. 2.

In the RAID 5, a combination of a chunk sequence and a checking block is referred to as a strip, for example A1, A2, A3, Ap as shown in FIG. 1. If a write operation is needed to be performed on the chunk, it is required to perform a recalculation based on the chunk of the strip and rewrite the corresponding parity checking block.

When a disk is offline, a recovery may be performed on an error chunk through parity checking blocks such as Ap, Bp, Cp, Dp of FIG. 1. Therefore, the RAID 5 has an error tolerant ability for one offline disk (that is, in a case that one disk is offline, the RAID 5 can recover it). However, the overall read-write performance of the disk decreases, since all the chunks and parity checking blocks need to be read to rebuild this chunk until the offline disk is replaced and the related data is rebuilt. The space efficiency of the RAID 5 is 1-1/n, where n is the number of the disks. For the case of 4 disks, each of which has 1 TB of data, an actual data storage space is 3 TB and the space efficiency is 75%. During reading of old data, if the number of the parity checking blocks calculated via the chunk is inconsistent with that in the disks, then it may be determined that there is a bad block. Therefore, in order to detect a bad block, it is required to read the chunks on n disks, and perform the parity checking calculation on each chunk. Thus the speed for determining the bad block greatly depends on the number of the disks.

The RAID 6 is an extension of the RAID 5, the principle of which is substantially the same as that of the RAID 5. The data distribution of the disks in the RAID 6 is shown as FIG. 2. Besides the parity checking blocks as shown in the RAID 5, there is added another parity checking block for each stripe in the RAID 6, such as Aq, Bq, Cq, Dq, Eq, thus enhancing the error tolerant ability for the bad disk. with the RAID 6, it is able to recover the data based on the redundant information in the case there are two offline disks, thus is applicable to the application environment with higher requirement for data security. However, the data write performance decreases, the parity checking calculation takes up more processing time, and space utilization rate of the effective data decreases.

The space efficiency of the RAID 6 is 1-2/n, and the RAID 6 has an error tolerant ability for two offline disk. For example, there are 5 disks, each of which has 1 TB of physical storage space. An actual data storage space is 3 TB and the space efficiency is 60%.

According to the current method for detecting bad block on disk, the utilization rate of space is low. In an internet industry application, due to a higher requirement on the data availability, there are generally one or more backups of the data to adequately ensure the data availability, and thus the error correction of data redundancy for single disk has little function on the scenario where there are multiple backups.

Further, the efficiency is not high in detecting bad black on the disk, Since the chunks and the checking blocks are distributed in respective disks, it is necessary to operate multiple disks for one check.

Further, it is unable to determine the bad block efficiently. When the detection is performed on the bad block on the disk, it is necessary to perform data check on the whole disk.

### SUMMARY

In view of this, the present disclosure provides a bad disk block self-detection method and apparatus and a computer storage medium, which can quickly detect the bad block on the disk, and it is able to instruct data migration and disk replacement.

The technical solutions of the present disclosure are implemented as follows. The present disclosure provides a bad disk block self-detection method, including: each mounted chunk is partitioned into n sub-chunks, all sub-chunks are of a same size, where n is an integer not less than 2;

checking information is set at a fixed location of each sub-chunk, data is stored onto locations of each sub-chunk other than the fixed location, where the checking information is parity checking information for the data; and

when the data is read or written, data verification is performed based on the checking information set at the fixed location of a read sub-chunk.

The present disclosure provides a bad disk block self-detection apparatus, including: a sub-chunk partitioning module, and a bad block scanning module.

The sub-chunk partitioning module is configured to partition each mounted chunk into n sub-chunks, all sub-chunks having a same size, where n is an integer not less than 2, and to set checking information at a fixed location of each sub-chunk, and to store data onto locations of each sub-chunk other than the fixed location, where the checking information is parity checking information for the data.

The bad block scanning module is configured to, when the data is read or written, perform data verification based on the checking information set at the fixed location of a read sub-chunk.

The present disclosure provides a computer storage medium with a computer program stored thereon, wherein the computer program is configured to perform the self-detection method mentioned above.

With the bad disk block self-detection method and apparatus as well as the computer storage medium, each mounted chunk is partitioned into n sub-chunks, all of which are of the same size, where n is an integer not less than 2; checking information is set at a fixed location of each sub-chunk, data is stored onto locations of each sub-chunk other than the fixed location, where the checking information is parity checking information for the data; and when the data is read or written, data verification is performed based on the checking information set at the fixed location of the read sub-chunk. In this way, the bad block on the disk can be detected rapidly, and it is able to instruct data migration and disk replacement.

### BRIEF DESCRIPTION OF THE DRAWINGS

FIG. 1 is a schematic diagram illustrating a data structure of a RAID 5 disk detection method according to the prior art;

FIG. 2 is a schematic diagram illustrating a data structure of a RAID 6 disk detection method according to the prior art;

FIG. 3 is a flow chart of a bad disk block self-detection method according to the present disclosure;

FIG. 4 is a schematic diagram illustrating a data structure of a sub-chunk according to an embodiment of the present disclosure;

FIG. 5 is a flow chart of step 102 according to an embodiment of the present disclosure;

FIG. 6 is a schematic diagram illustrating different service data are distributed to different chunks according to an embodiment of the present disclosure;

FIG. 7 is a schematic diagram illustrating a structure of a bad disk block self-detection apparatus according to the present disclosure; and

FIG. 8 is a schematic diagram illustrating service data verification between a bad disk block self-detection apparatus according to the present disclosure and a service system.

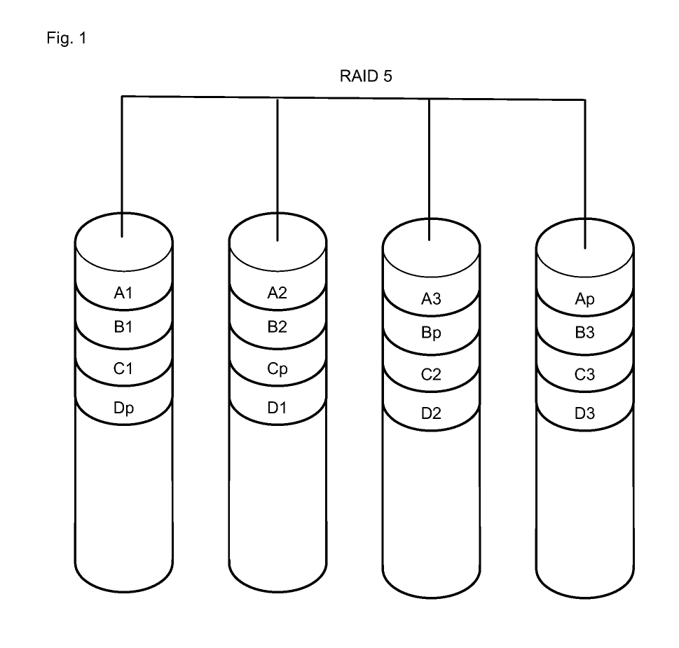

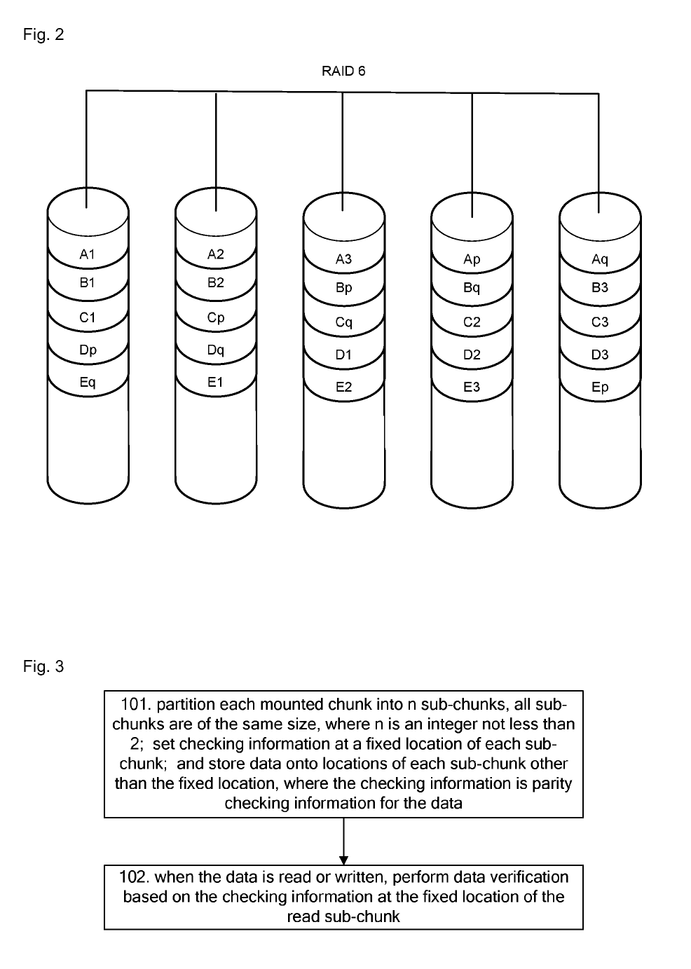

### DETAILED DESCRIPTION

According to various embodiments of the present disclosure, each mounted chunk is partitioned into n sub-chunks, all of the n sub-chunks have the same size, where n is an integer not less than 2; checking information is set at a fixed location of each sub-chunk, data is stored onto locations of each sub-chunk other than the fixed location, where the checking information is parity checking information for the data; when the data is read or written, data verification is performed based on the checking information set at the fixed location of the read sub-chunk.

The technical solutions of present disclosure will be further elaborated below with reference to the accompanying drawings and specific embodiments.

The present disclosure provides a bad disk block self-detection method. As shown in FIG. 3, the method includes the following steps.

In step 101, each mounted chunk is partitioned into n sub-chunks, all sub-chunks are of the same size, where n is an integer not less than 2; checking information is set at a fixed location of each sub-chunk, data is stored onto locations of each sub-chunk other than the fixed location, where the checking information is parity checking information for the data.

Specifically, a storage server may partition each mounted chunk into n sub-chunks. Each sub-chunk may be of 65K. Each sub-chunk includes a data field of 64K and a checking field of 1K. The parity checking information for the data which is stored in the data field is set in the parity checking field.

A starting address of each mounted chunk may be a physical address of a corresponding disk.

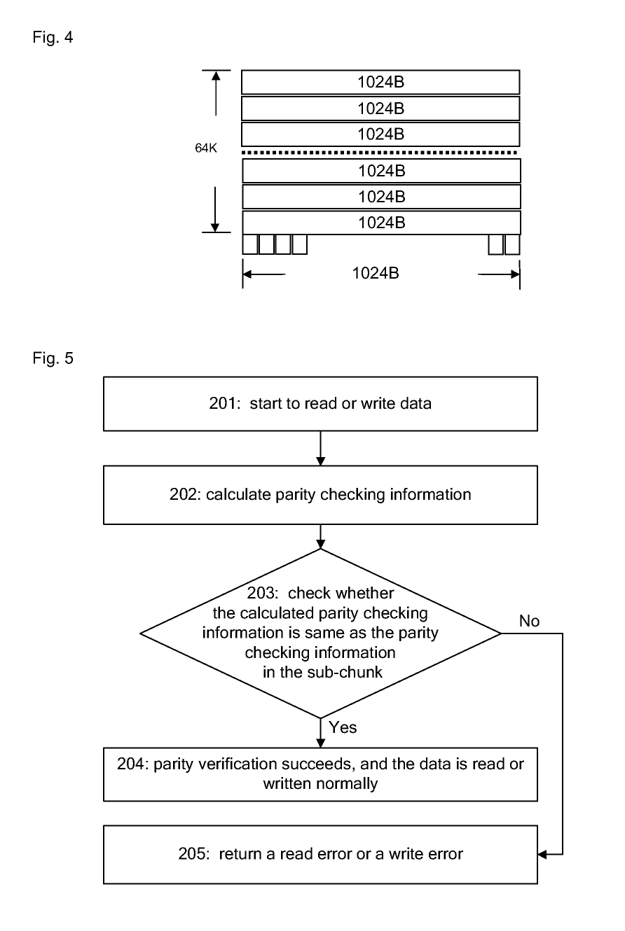

Taking a chunk server as an example, m chunks are mounted at the chunk server, where the starting address of each chunk is the physical address of the disk. The chunk server partitions each chunk into n sub-chunks. Each sub-chunk is of 65K, and includes a data field of 64K and a parity checking field of 1K. The chunk server sets parity checking information for the data stored in the data field into the parity checking field. Data distribution of each sub-chunk is shown in FIG. 4, where each 1K bytes in the data field is considered as a row and there are 1024×8 bits in total, i.e., each sub-chunk includes 64 data rows and one parity checking row. Each bit of the parity checking row is a parity check sum of corresponding bits in all the rows in the data field, as shown in formula (1):

Bit(i)=Column₁(i)xor Column₂(i)xor Column₆₄(i) i=1 . . . 1024×8 (1),

where Bit(i) is the i^{th} bit of the parity checking row; Columnⱼ(i) is a parity checking value of the i^{th} bit of the j^{th} row in the data field.

Here, due to that the chunk is partitioned into sub-chunk with fixed length, both the data and the parity checking information are stored onto respective fixed physical locations of the sub-chunk.

In step 102, when the data is read or written, data verification is performed based on the checking information at the fixed location of the read sub-chunk.

As shown in FIG. 5, step 102 may specifically include the following steps.

In step 201, it is started to read or write data.

Specifically, when an in-out (IO) read-write operation is performed on the disk, the data is read or written based on the size of the sub-chunk. The storage server converts a relative address for reading or writing the data to a physical address of the disk, and reads the sub-chunk from the chunk, the physical address of which is the starting address.

In step 202, it is calculated the parity checking information for the sub-chunk.

In step 203, it is checked whether the calculated parity checking information is same as the parity checking information in the sub-chunk, if so, proceed to step 204; otherwise, proceed to step 205.

Specifically, the calculated parity checking information is compared with the parity checking information in the sub-chunk, if they are same, proceed to step 204; otherwise, proceed to step 205.

In step 204, the parity verification succeeds, and the data is read or written normally;

In step 205, a read error or a write error is returned.

Further, step 205 may also include: it is read backup data to ensure data availability, and the storage server records information of the chunk containing the sub-chunk which does not pass the parity verification, so as to rebuild or ignore the chunk.

For example, if the storage server in step 101 is a chunk server, the IO read-write operation may be performed on the disk in a unit of 65K (that is, every time the IO read-write operation is performed, it is read or written a sub-chunk of 65K). The chunk server may convert the relative address for reading or writing the data to the physical address of the disk, read a sub-chunk from the chunk whose physical address is the starting address, calculate parity checking information corresponding to the data field in the sub-chunk, and compare the calculated parity checking information with the parity checking information located at the parity checking field in the sub-chunk. If they are same, it indicates the parity verification succeeds, and the data can be read or written normally. If they are not same, a read error or a write error is sent, and further, the backup data may be read to ensure data availability, and the chunk server may record information of the chunk which does not pass the parity verification, so as to rebuild the chunk or ignore it.

With this method, in terms of disk operation, only one IO operation is required to be performed on a single disk each time a chunk is read/written or detected, thus significantly reducing the number of times of IO operation on the detected disks. It is easy to operate and implement this method, thereby improving detection efficiency. In term of data storage efficiency, the utilization rate of space reaches up to 98.4%, which has a great advantage compared to the RAID 5 and RAID 6.

The above method may further include: the storage server arranges the mounted chunks into a logical sequence, distributes various service data onto different chunks, and establishes a mapping table between the services and the chunks. When an abnormality occurs to a service, the storage server adds a chunk which bears the abnormal service into a bad block scanning queue based on the mapping table. The storage server may perform data verification on each sub-chunk of each chunk in the bad block scanning queue. Specifically, it is calculated the parity checking information for each sub-chunk, and compared the calculated parity checking information and the parity checking information in the sub-chunk.

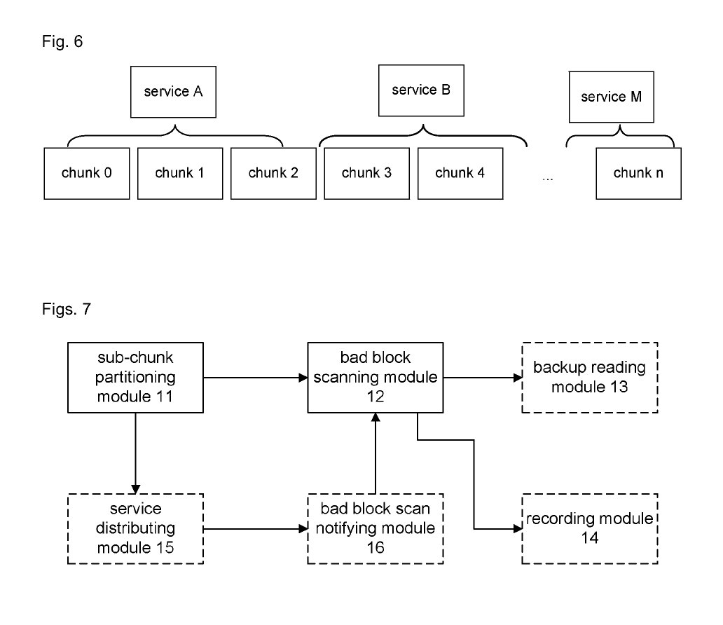

Take the chunk server as an example, the chunk server may arrange the mounted chunks into a one-dimension block logical sequence, distribute various service data onto different chunks, establish a mapping table between the services and the chunks. As shown in FIG. 6, data corresponding to service A, service B, up to service M are distributed onto chunk 0, chunk 1, chunk 2, chunk 3, chunk 4 . . . chunk n, respectively. When an abnormality occurs to a service, for example, there are many IO errors during data upload/download or a throughput of the disk declines, the chunk which bears the abnormal service may be added into a bad block scanning queue based on the mapping table, and the chunk server performs data verification on each sub-chunk of each chunk in the bad block scanning queue., thus enabling a more directed scan, enhancing the accuracy of bad block detection, and reducing the impact of scanning on the lifetime of the disk.

Further, the chunk server may maintain a list table of bad block information, in which the bad block information is stored, including: a logical sequence numbering of the chunk, a corresponding numbering of the chunk, a detection time for a bad block. By means of the maintained list table of bad block information, the chunk server can, on one hand, avoid performing data writing on the bad block, and reducing the probability that new data is written into the bad block; and on the other hand, the detection time for a bad block may be used to estimate a generating speed of the bad block of a physical disk. Generally, when a bad sector appears in the disk, it means more bad sectors will come. Therefore, when the proportion of the bad blocks in the disk exceeds a certain threshold or the generating speed of the bad block exceeds a threshold, the chunk server may send an alarm to an operation and maintenance system, so that the operation and maintenance system is notified to perform data migration and replace the disk in time, and remove the corresponding bad block sequence from the list table of the bad block on the chunk server, and thus the data security is better guaranteed.

To achieve the above method, the present disclosure also provides a bad disk block self-detection apparatus. As shown in FIG. 7, the apparatus is configured in a storage server, and includes a sub-chunk partitioning module 11 and a bad block scanning module 12.

the sub-chunk partitioning module 11 is configured to partition each mounted chunk into n sub-chunks, all sub-chunks have a same size, and n is an integer not less than 2. The sub-chunk partitioning module 11 is also configured to set checking information at a fixed location of each sub-chunk, and to store data onto locations of each sub-chunk other than the fixed location, where the checking information is parity checking information for the data.

The bad block scanning module 12 is configured to, when the data is read or written, perform data verification based on the checking information set at the fixed location of the read sub-chunk.

The sub-chunk partitioning module 11 may be specifically configured to partition each mounted chunk into n sub-chunks, each sub-chunk having a size of 65K and consisting of a data field of 64K and a parity checking field of 1K, and to set in the parity checking field the parity checking information for the data which is stored in the data field.

The bad block scanning module 12 may be specifically configured to, when a read operation or a write operation is performed, read or write the data based on the size of the sub-chunk, to convert a relative address for reading or writing the data to a physical address of the disk, to read the sub-chunk from the chunk whose physical address is a starting address, to calculate the parity checking information for the sub-chunk, and to compare the calculated parity checking information with the parity checking information in the sub-chunk. If the calculated parity checking information is same with the parity checking information in the sub-chunk, it indicates the parity verification succeeds; otherwise, the parity verification fails, and it is sent a read error or a write error.

The apparatus may also include a backup reading module 13. The backup reading module 13 is configured to, after the read error or the write error is sent by the bad block scanning module, read backup data to ensure data availability.

The apparatus may also include a recording module 14. The recording module 14 is configured to record information of the chunk containing a sub-chunk which does not pass the parity verification, so as to rebuild or ignore the chunk.

The apparatus may also include a service distributing module 15 and a bad block scan notifying module 16.

The service distributing module 15 may be configured to arrange the mounted chunks into a logical sequence, to distribute various service data onto different chunks, and to establish a mapping table between the services and the chunks.

The bad block scan notifying module 16 may be configured to, when an abnormality occurs to a service, add a chunk which bears the abnormal service into a bad block scanning queue based on the mapping table, and to notify the bad block scanning module. The bad block scanning module 12 may be further configured to perform the data verification on each sub-chunk of each chunk in the bad block scanning queue. The process of the data verification is specifically described in step 102, which is not repeated here.

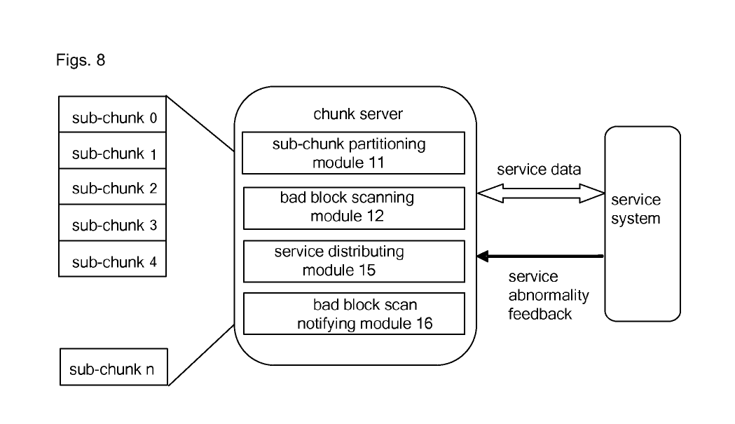

When the apparatus is set in the chunk server, as shown in FIG. 8, the sub-chunk partitioning module 11 is specifically configured to partition each chunk into n sub-chunks, each of which is of 65K and includes a data field of 64K and a parity checking field of 1K, and to set in the parity checking field the parity checking information for the data which is stored in the data field.

The bad block scanning module 12 is specifically configured to, every time the IO read-write operation is performed on the disk in the unit of 65K, convert the relative address for reading or writing the data to the physical address of the disk, to read the sub-chunk from the chunk whose physical address is the starting address, to calculate the parity checking information corresponding to the data field in the sub-chunk, and compare the calculated parity checking information with the parity checking information in the parity checking field of the sub-chunk. If the calculated parity checking information is same with the parity checking information in the parity checking field of the sub-chunk, it indicates the parity verification succeeds, and the data can be read or written normally; otherwise, a read error or a write error is sent.

The service distributing module 15 may be configured to arrange the mounted chunks into the logical sequence, to distribute the various service data of a service system onto different chunks, and to establish a mapping table between the services and the chunks.

The bad block scan notifying module 16 may be configured to, when an abnormality occurs to a service, add a chunk which bears the abnormal service into the bad block scanning queue based on the mapping table, and to notify the bad block scanning module.

The bad block scanning module 12 may be further configured to perform the data verification on each sub-chunk of each chunk in the bad block scanning queue. The process of the data verification is specifically described in step 102, which is omitted here.

The modules mentioned above are classified based on logical functions. In a practical application, a function of one module may be implemented by multiple modules, or functions of multiple modules may also be implemented by one module.

When implemented in form of a software functional module and sold or used as an independent product, the bad disk block self-detection method in embodiments of the present disclosure may be stored in a computer-readable storage medium. Based on such an understanding, the essential part (or a part of the technical solution of an embodiment of the present disclosure contributing to prior art) may appear in form of a software product, which software product is stored in a storage medium, and includes a number of instructions for allowing a computing equipment (such as a personal computer, a server, a network equipment, or the like) to execute all or part of the methods in various embodiments of the present disclosure. The storage media include various media that can store program codes, such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the present disclosure further provides a computer storage medium, which stores a computer program configured to perform the bad disk block self-detection method according to the embodiments of the present disclosure.

What described are merely preferred embodiments of the disclosure, and are not intended to limit the scope of the present disclosure.

1-3. (canceled)

4. A bad disk block self-detection method, comprising:
partitioning each mounted chunk into n sub-chunks, all sub-chunks having a same size, n being an integer not less than 2;
setting checking information at a fixed location of each sub-chunk, storing data onto locations of each sub-chunk other than the fixed location, wherein the checking information is parity checking information for the data; and
when the data is read or written, performing data verification based on the checking information set at the fixed location of a read sub-chunk,
wherein when the data is read or written, performing data verification based on the checking information set at the fixed location of a read sub-chunk, comprises:
when a read operation or a write operation is performed, reading or writing the data based on the size of the sub-chunk;
converting a relative address for reading or writing the data to a physical address of a disk;
reading the sub-chunk from the chunk whose physical address is a starting address;
calculating the parity checking information for the sub-chunk; and
comparing the calculated parity checking information with the parity checking information in the sub-chunk.

5. A bad disk block self-detection method, comprising:
partitioning each mounted chunk into n sub-chunks, all sub-chunks having a same size, n being an integer not less than 2;
setting checking information at a fixed location of each sub-chunk, storing data onto locations of each sub-chunk other than the fixed location, wherein the checking information is parity checking information for the data;
when the data is read or written, performing data verification based on the checking information set at the fixed location of a read sub-chunk;
arranging the mounted chunks into a logical sequence;
distributing various service data onto respective chunks;
establishing a mapping table between the services and the chunks;
when an abnormality occurs to a service, adding a chunk which bears the abnormal service into a bad block scanning queue based on the mapping table; and
performing the data verification on each sub-chunk of each chunk in the bad block scanning queue.

6. The self-detection method according to claim 5, wherein the performing the data verification on each sub-chunk of each chunk in the bad block scanning queue comprises: calculating the parity checking information for the sub-chunk, and comparing the calculated parity checking information with the parity checking information in the sub-chunk.

7. A bad disk block self-detection apparatus, comprising:
a sub-chunk partitioning module configured to partition each mounted chunk into n sub-chunks, all sub-chunks having a same size, n being an integer not less than 2, to set checking information at a fixed location of each sub-chunk, and to store data onto locations of each sub-chunk other than the fixed location, wherein the checking information is parity checking information for the data; and
a bad block scanning module configured to, when the data is read or written, perform data verification based on the checking information set at the fixed location of a read sub-chunk,
wherein the sub-chunk partitioning module is configured to partition each mounted chunk into n sub-chunks, each sub-chunk having a size of 65K and consisting of a data field of 64K and a parity checking field of 1K, and to set in the parity checking field the parity checking information for the data which is stored in the data field,
wherein the bad block scanning module is configured to, when a read operation or a write operation is performed, read or write the data based on the size of the sub-chunk, to convert a relative address for reading or writing the data to a physical address of a disk, to read the sub-chunk from the chunk whose physical address is a starting address, to calculate the parity checking information for the sub-chunk, and to compare the calculated parity checking information with the parity checking information in the sub-chunk.

8-9. (canceled)

10. A bad disk block self-detection apparatus, comprising:
a sub-chunk partitioning module configured to partition each mounted chunk into n sub-chunks, all sub-chunks having a same size, n being an integer not less than 2, to set checking information at a fixed location of each sub-chunk, and to store data onto locations of each sub-chunk other than the fixed location, wherein the checking information is parity checking information for the data;
a bad block scanning module configured to, when the data is read or written, perform data verification based on the checking information set at the fixed location of a read sub-chunk;
a service distributing module configured to arrange the mounted chunks into a logical sequence, to distribute various service data onto respective chunks, and to establish a mapping table between the services and the chunks; and
a bad block scan notifying module configured to, when an abnormality occurs to a service, add a chunk which bears the abnormal service into a bad block scanning queue based on the mapping table, and to notify the bad block scanning module,
wherein the bad block scanning module is further configured to perform the data verification on each sub-chunk of each chunk in the bad block scanning queue.

11. (canceled)

12. The self-detection method according to claim 4, wherein the partitioning each mounted chunk into n sub-chunks, all sub-chunks having a same size, n being an integer not less than 2, comprises:
partitioning each mounted chunk into n sub-chunks, wherein each sub-chunk has a size of 65K and consists of a data field of 64K and a parity checking field of 1K; and
setting in the parity checking field the parity checking information for the data which is stored in the data field.

13. The self-detection method according to claim 4, wherein the data is read or written based on the size of the sub-chunk.
